(19) United States
(12) Patent Application Publication
(10) Pub. No.: US 2015/0084313 A1
(43) Pub. Date: Mar. 26, 2015

(54) FOLDING CHASSIS FOR AN UMBRELLA-FOLD CHILD'S PUSHCHAIR

(71) Applicant: NAPA VALLEY, Luxembourg (LU)

(72) Inventors: Jerome Tricault, Langoiran (FR); Emmanuel Sordoillet, Anglet (FR)

(73) Assignee: NAPA VALLEY, Luxembourg (LU)

(21) Appl. No.: 14/394,385

(22) PCT Filed: Apr. 26, 2013
(86) PCT No.: PCT/EP2013/058699

§ 371 Date: Oct. 14, 2014

(30) Foreign Application Priority Data
Apr. 27, 2012 (FR) 12 53941

(51) Int. Cl. B62B 7/06; B62B 7/00

(52) U.S. Cl. CPC B62B 7/068; B62B 7/004
USPC 280/650

(57) ABSTRACT

A folding chassis (1) for a child's pushchair comprising a plurality of up members (10, 11, 13, 13) for supporting the wheels and a support for the child, in which at least two members (10, 11, 13, 13) of said plurality of members are articulated to one another in such a way that when the chassis is in a deployed configuration the angular separation between these two members is higher than it is when the chassis is in a folded configuration, and in which each one of said two members comprises several parts (1021, 1022, 1121, 1122, 121, 122, 131, 132) able to slide relative to one another in a longitudinal direction of said member.

The invention relates to a folding umbrella-fold child's pushchair device, and in particular to the chassis of this pushchair device.

“Child's pushchair” is to be understood as meaning, equally, “child's pushchair”, “baby's pushchair” or “doll's pushchair”.

There are many folding umbrella-fold pushchairs. An umbrella-fold pushchair comprises at least one, and conventionally two, first struts, these being at an angle when the pushchair is in the unfolded configuration, supporting at least one front wheel and a child support, and at least one, and conventionally two, second struts, for supporting at least one rear wheel. At least one first strut and at least one second strut are articulated to one another, such that when in the folded configuration these struts are folded back against one another. One may mention for example the umbrella-fold pushchairs described in documents EP 2 014 536 and GB 2480279.

There exists a need for a folding umbrella-fold pushchair device which is more compact when in the folded configuration.

The invention proposes a folding chassis for an umbrella-fold child's pushchair, comprising:
at least one first strut, termed the front strut, for supporting at least one front wheel at the front of the chassis and a child support,
at least one second strut for supporting at least one rear wheel at the rear of the chassis.

At least one first strut and at least one second strut are articulated to one another such that, when the chassis is in an opened configuration, the first strut is at an angle to the plane of the wheels and extends from the front to the rear of the chassis and, when the chassis is in a folded configuration, the angular separation between these two struts is smaller than when the chassis is in an opened configuration.

According to the invention, each of said two struts articulated to one another comprises several portions designed to slide with respect to one another in a longitudinal direction of said strut.

Thus, when passing from the opened configuration to the folded configuration, a rotation movement of at least one of these two struts with respect to the other is combined with a sliding movement of each of these two struts, which may make it possible to obtain a chassis which is particularly compact when in the folded configuration.

For example, when folding the chassis, it is possible to provide that these two struts be brought back against one another, and then that each strut be shortened by sliding its respective portions.

As a variant, it would be possible to provide that, first, each of the two struts be shortened by sliding its respective portions with respect to one another, and then that these two shortened struts be brought back against one another.

The invention is in no way limited to a perfect alignment of the two struts in the folded configuration. The angular separation between these two struts in the folded configuration may be 0°, less than 5°, or greater than 5°, for example 15°.

Thus, in the opened state, the first strut forms a non-right angle, for example between 5° and 85°, advantageously between 25° and 65°, for example close to 45°, with the plane of the wheels.

The first strut may extend from the front of the chassis, from an end close to which or on which is attached at least one front wheel, toward the rear of the chassis, as far as an end on which is attached a handle element. The handle element may for example be a handle, a stem plus handle assembly, or the like.

The struts may be made of metal or any other material.

Each second strut may be a lower strut for supporting at least one front wheel at the front of the chassis and at least one rear wheel at the rear of the chassis, the lower strut extending from the front to the rear of the chassis. The articulation between the lower strut and the front strut is then at the level of the one or more front wheel(s).

Alternatively, each second strut may be a rear strut extending on one hand toward at least one rear wheel and on the other hand toward user handles. The articulation between the lower strut and the front strut is then at the level of the handles.

In another embodiment, it is possible to provide that one of the two struts comprise a front leg at the end of which at least one wheel is installed, and that the other of these two struts comprise a rear leg at the end of which at least one rear wheel is installed. Thus, the articulation between these two struts is at the level of the child seat rather than at the level of the front wheels. A chassis of this type would be in the shape of an inverted Y (and with an oblique bar) when seen from the side. When passing into the folded configuration, the rear legs are closed up against the front legs, by a rotation movement about a transverse axis at the level of the seat, then the front and rear legs are shortened by telescoping.

The invention is in no way limited by the shape or by the arrangement of these two struts articulated to one another. For example, it is possible to provide that the portions designed to slide with respect to one another be tubes which can telescope into one another, or even that at least one of the two struts comprise two tubes supported by a sleeve-type guide, at least one of these tubes being designed to slide with respect to this guide.

Advantageously, each of the first and second struts of the chassis comprises several portions designed to slide with respect to one another in a longitudinal direction of said strut. Thus, all of the structural elements of the chassis may for example be telescopic.

The child support may hang from the first strut(s). It may for example be a hammock-type seat.

Also proposed is a folding chassis for a child's pushchair device, comprising multiple struts for supporting wheels and a child support. At least two struts among these multiple struts are articulated to one another such that, when the chassis is in an opened configuration, the angular separation between these two struts is greater than when the chassis is in a folded configuration. Moreover, each of these two struts comprises several portions designed to slide with respect to one another in a longitudinal direction of the respective strut.

Advantageously and without limitation, the at least two struts may comprise at least one strut arranged so as to support the child support, for example a front strut, and at least one strut arranged so as to support at least one rear wheel, for example a rear leg or a lower strut.

Advantageously and without limitation, at least one of these two struts may comprise a front leg designed to support a child support.

At least one front wheel may be installed at a front end of this front leg.

Advantageously, and without limitation, at least one of these two struts may comprise a lower strut designed to support at least one front wheel and at least one rear wheel. Thus, the front leg and the lower strut may be brought back against one another by a rotation movement about a transverse axis close to the front wheels, and then be shortened, for example by telescoping.

In the present application, “articulated”, is to be understood both as “directly articulated” to one another, and as “indirectly articulated”. Thus, the two struts may be directly secured to one another or may be secured to one another via the intermediary of one or more other parts. These parts may be fixed with respect to one another, or not.

The chassis may comprise exactly two struts articulated to one another and designed in several portions able to slide with respect to one another, or more.

In one advantageous embodiment, it is possible to provide four struts in several portions able to slide with respect to one another, wherein each of these four struts is articulated with respect to at least one other of these struts.

For example, two first struts may make it possible to support the child support and at least one front wheel, and two second struts may make it possible to support the at least one front wheel and at least one rear wheel.

In particular, it is possible to provide two front struts for supporting the seat support, at the end of which are installed two respective front wheels, and two other struts, for example two lower struts. A respective front wheel and a respective rear wheel are installed at each of these lower struts.

The invention is in no way limited by this form of pushchair. It is for example possible to provide two telescopic front struts, and a single telescopic lower strut, to which the wheels would be secured, via shorter stems, for example transverse stems which can be folded against this lower strut.

Advantageously and without limitation, when the chassis is in the opened configuration, the two first struts may form an angle between them and/or the two second struts may form an angle between them.

Advantageously and without limitation, the chassis may be arranged such that, when passing from the opened configuration to the folded configuration, the angle between the two first struts and/or the angle between the two second struts decrease(s).

Thus, the chassis in the folded configuration may be relatively narrow in comparison with the chassis in the opened configuration.

The chassis may in particular be arranged such that, in the opened configuration, the front portion of the chassis is narrower than the rear portion of the chassis.

It is possible to provide a single front wheel or two front wheels.

The invention is in no way limited by this feature. It is for example possible to provide a chassis arranged such that, in the opened configuration, the two front struts are parallel or substantially parallel to one another.

In one embodiment, the two first struts are parallel to one another and/or the two second struts are parallel to one another when the chassis is in the opened configuration.

Advantageously and without limitation, the chassis may be arranged so as to allow the front wheels to be brought closer to one another when passing into the folded configuration. It is thus possible to reduce the width of the chassis when passing into the folded configuration.

Advantageously and without limitation, the chassis may comprise two stem elements articulated to one another at two respective ends, and articulated respectively to a right portion and to a left portion of the chassis at the two other respective ends. The angular separation between these two stem elements may be reduced when passing into the folded configuration.

The left and right portions of the chassis may for example comprise two first respective struts, each supporting a respective front wheel. Thus, when the stem elements are made to move, for example in order to reduce the angular separation between these stem elements or to fold them against one another, the ends of these two first struts are also made to move, so as to bring them close to one another, thus allowing greater compactness in the folded state.

Advantageously and without limitation, the chassis may comprise a handle secured by an articulated connection to these two stem elements, at the level of the articulation between these two stem elements. Thus, the user may fold the two stem elements by exerting a force on this handle.

Advantageously and without limitation, the chassis may comprise means to cause at least some of the portions of these at least two struts to slide simultaneously. It is thus possible to shorten these two struts in a single action.

It is for example possible to provide that two ends of the two respective struts are secured to one and the same element which can be manipulated by the user. The user then need only pull on or push this element to cause the various portions of these two struts to slide.

Advantageously and without limitation, the chassis may comprise means for causing the at least two struts to move together in the angular direction.

Advantageously, the means for causing the two struts to move together in the angular direction and the means for causing the various portions of these two struts to slide simultaneously may be combined.

Advantageously and without limitation, it is possible to provide, for each of the two struts, a stem mounted articulated to one end of this strut, for example an end opposite the end forming an articulation between these two struts.

These two stems may be secured to one and the same tool forming a handle. Thus, when the user pulls or pushes this handle, these two stems are folded back against one another and cause the two struts to be folded back against one another. Then, if the user continues to exert the same force on the tool forming a handle, the ends articulated to the stems are brought closer to the articulation end due to the various portions of each stem sliding with respect to one another.

Advantageously and without limitation, the tool forming a handle may be generally stem-shaped. This may facilitate the actions of the user. Alternatively, it is for example possible to provide that the user must reach inside the chassis to take hold of a handle at a connection point between the stems articulated to the struts.

Advantageously and without limitation, the chassis may be arranged such that the tool forming a handle is brought toward the front of the chassis when passing into the folded configuration. The user must thus pull or push this element in order to obtain the folded configuration.

Advantageously and without limitation, the chassis may be arranged such that this tool forming a handle comprises a stem having an end articulated to the two stems which are themselves articulated to the two struts, and another end forming a handle arranged at the front of the chassis.

In order to fold the pushchair, the user must thus pull on this stem, which causes the two struts to fold with respect to one another and causes the various portions of these two struts to slide.

Advantageously and without limitation, this generally stem-shaped tool may itself comprise several portions which are able to slide with respect to one another.

Thus, when the two struts are brought back against one another and are telescoped so as to reduce their respective lengths, the user may shorten the generally stem-shaped tool by telescoping, by causing the various portions of these stems to slide against one another. For example, the user brings the struts back against one another and shortens these struts by pulling on the generally stem-shaped tool, then shortens this tool by pushing on the various portions of this generally stem-shaped tool.

Advantageously and without limitation, the angular reduction movement between the two struts may lead to a reduction in the height of the chassis. In other words, the struts may be folded back against one another following a direction having a vertical component.

Advantageously and without limitation, the angular reduction movement between the struts may make it possible to reduce the width of the chassis. In other words, the struts may be folded back against one another following a direction having a lateral component.

It is for example possible to provide three or four struts arranged, in the opened configuration, such that their front ends are closer to one another than their rear ends. When passing into the folded configuration, such a bundle of struts is brought back in on itself until the struts are parallel or substantially parallel to one another, similar to an umbrella. It is thus possible to reduce both the height and the width of the chassis during this angular reduction movement.

The invention is in no way limited to a reduction in the width of the chassis during the movement of reducing the angle between the struts. It is for example possible to provide two mutually parallel front struts and two lower struts, also mutually parallel. Each front strut corresponds to a lower strut of the same side. Each front strut is articulated to the lower strut of the same side, the two front struts are secured to one another via the intermediary of two stems which are articulated to one another. In the opened configuration, these two stems are in the continuation of one another, which corresponds to a maximum width of the chassis. When passing into the folded configuration, the user undoes a rigid connection between these two stems, and allows the width to be reduced by folding these two stems back on each other.

In one advantageous embodiment:
both the height and the width are reduced by the angular reduction movement,
the width of the chassis is reduced by bringing the front wheels closer together, and
the length of the chassis is reduced by the sliding movement of the various strut portions.

The invention is in no way limited by the shape of the means implemented to bring the struts back against one another and/or to telescope these struts.

In the case of a pushchair having four articulated and telescopic struts, it is possible to provide at least three, and preferably four, stems each having one end articulated to a respective strut.

Advantageously and without limitation, these at least three and preferably four stems may have respective ends opposite the ends mounted on the struts, secured at one and the same connection point.

Such a Y-shaped structure, in the case of three struts, or X-shaped structure in the case of four struts, may thus make it possible to pass from the opened configuration to the folded configuration by moving the three or four stems in the same direction.

Advantageously and without limitation, the connection point of the three or four stem ends may be located outside the planes comprising two of the struts, for example in a region which is central with respect to these struts.

The invention is in no way limited by such a Y-shaped or X-shaped structure. For example, it is possible to provide that the stems secured to the front strut on the right-hand side, and to the lower strut of the same right-hand side, are secured to one another in a connection which is articulated substantially in the plane of the struts of the right-hand side, and, in the same manner, that the stems secured to the front strut on the left-hand side, and to the lower strut of this same left-hand side, are secured to one another by a connection which is articulated substantially in the plane of the struts of the left-hand side. These four stems would thus be oriented vertically or substantially vertically. It would also be possible to provide two stems, positioned substantially in a horizontal plane and articulated to one another by one end, and having their other ends articulated to the connection point between the vertical stems. Such an H-shaped structure may be mechanically relatively easy to produce.

Advantageously and without limitation, the chassis may comprise means for locking the chassis in the opened configuration. For example, these locking means may comprise a finger which is mounted on a spring on a telescopic tube of a strut and is able to abut against the end of another telescopic tube, of greater diameter, of this strut, due to the push force exerted by the spring.

Advantageously and without limitation, the locking means may comprise means for locking the generally stem-shaped tool. By locking this tool, it is possible to prevent the X-, Y-, H- or otherwise-shaped structure, and thus the entire chassis, from moving, in particular when a connection element of this X- or otherwise-shaped structure is arranged so as to prevent the stems articulated to the struts from tipping beyond a certain angle.

Advantageously and without limitation, the means for locking the generally stem-shaped tool may be arranged so as to lock the end of the generally stem-shaped tool with respect to the struts.

Advantageously and without limitation, the means for locking the generally stem-shaped tool may comprise a projection extending from this generally stem-shaped tool, and a guide defining a passage for this generally stem-shaped tool, and defining a cavity for receiving the projection so as to lock the generally stem-shaped tool.

The projection may for example comprise a finger mounted on a spring, which is received in the cavity of the guide, for example a through hole. The generally stem-shaped tool may be arranged so as to allow this finger to be retracted via a mechanism controlled by a button on the handle installed at the end of the generally stem-shaped tool.

Alternatively, the projection may be secured to the generally stem-shaped tool by means of a rigid connection, and may in particular be integrally formed with this tool. It is possible to provide that the projection is engaged in or disengaged from the cavity by rotating the generally stem-shaped tool on itself, about its own longitudinal axis, possibly preceded and/or followed by a push or pull motion, depending on the shape of the cavity.

Advantageously and without limitation, the means for locking the generally stem-shaped tool may be arranged so as to prevent the various portions of the generally stem-shaped tool from telescoping.

For example, this tool may comprise, close to one end of one of its tubes, able to be retracted into another tube of the tool, a finger which is mounted on a spring and is able to abut against the section of this other tube so as to prevent the tubes from telescoping into one another. This finger may be unlocked via a mechanism secured to the button of the handle.

Advantageously and without limitation, the chassis may be arranged so as to engage the locking means as a consequence of passing into the opened configuration. Locking is thus performed without a specific locking action on the part of the user.

Advantageously and without limitation, the chassis may be arranged so as to disengage the locking means following an action on the part of the user. It is for example possible to provide a mechanism controlled by a pushbutton. Before folding the pushchair, the user unlocks the chassis.

Advantageously and without limitation, the chassis may comprise pushing arms.

Advantageously and without limitation, the chassis may be arranged such that these pushing arms are able to slide with respect to the rest of the chassis.

Advantageously and without limitation, the chassis may comprise means for locking the pushing arms which are arranged such that the pushing arms can be locked in several positions. Locking may advantageously be carried out continuously over a whole range of positions. The user may thus adjust the pushing arms at their convenience.

Also proposed is a pushchair device comprising a chassis as described hereinabove, a child support, for example a hammock-type baby seat, and wheels.

In the present application, the terms “up”, “down”, “upper”, “lower”, “vertical”, “horizontal”, “lateral”, “above”, “below”, etc. are defined in the conventional meaning of these terms, that is to say that the vertical direction is the direction of the gravity vector, this gravity vector being oriented from up to down for a chassis of a pushchair placed with the wheels resting on ground perpendicular to the gravity vector. Of course, the chassis may be oriented differently, in particular when the ground is sloping or when it is in the folded configuration.

The invention will be better understood with reference to the figures, which show embodiments given by way of example.

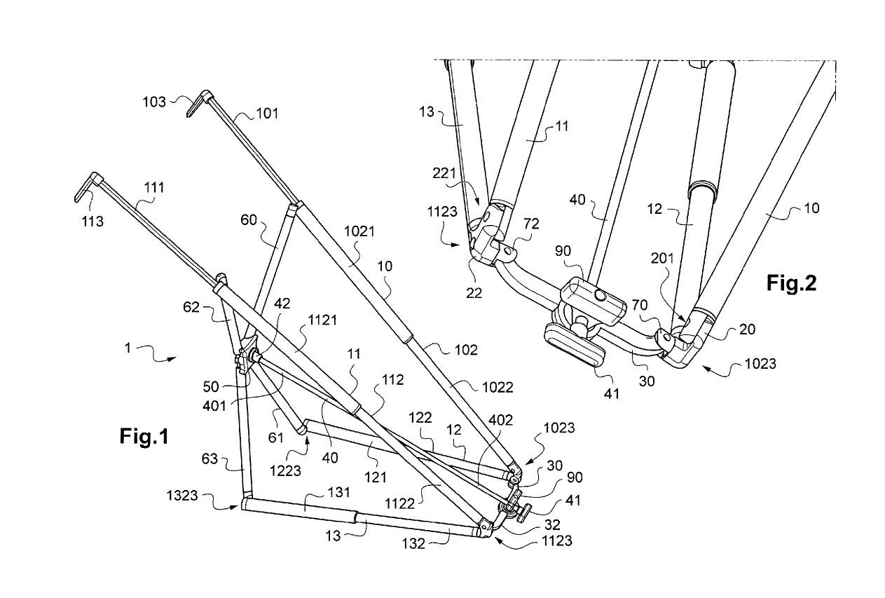

FIG. 1 is a perspective view of an example of a chassis for a child's pushchair according to one embodiment of the invention.

FIG. 2 is a perspective view from the front of a detail of the front of the chassis of FIG. 1.

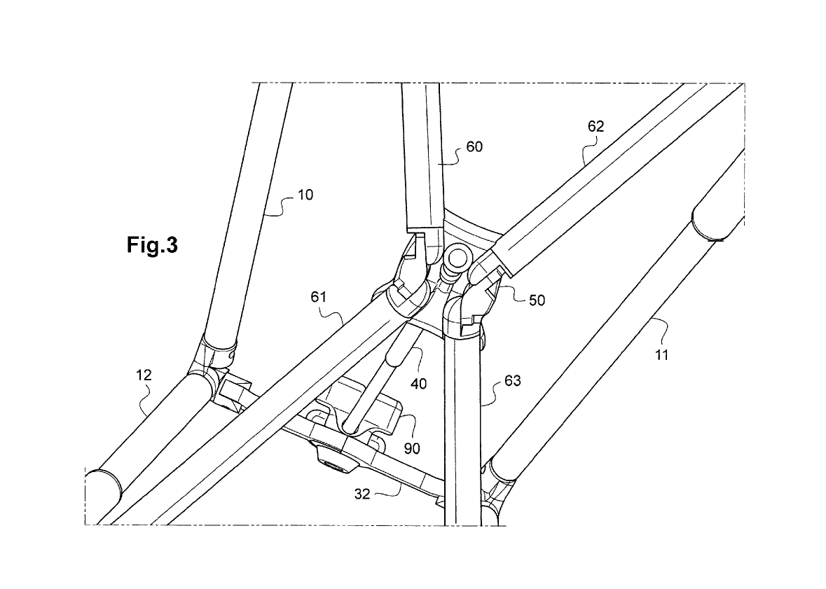

FIG. 3 is a perspective view from the rear of a detail of the rear of the chassis of FIG. 1.

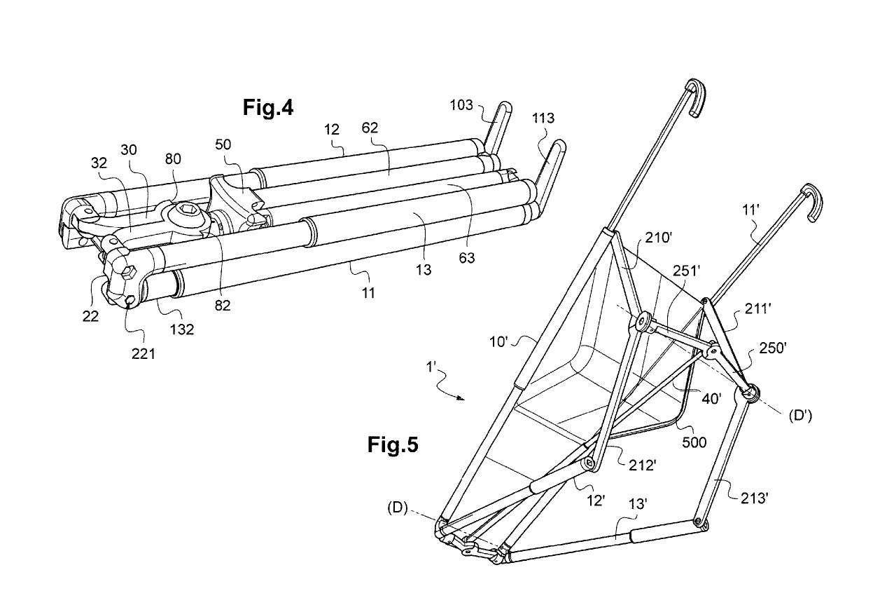

FIG. 4 is a perspective view from below of the chassis of FIG. 1 when in the folded configuration.

FIG. 5 is a perspective view from below of an example of the chassis according to another embodiment, with a child seat.

Identical references may be used from one figure to the other to designate identical or similar elements.

As FIGS. 1 to 4 relate to the same embodiment, they will be discussed simultaneously.

With reference to these figures, the chassis 1 comprises four struts 10, 11, 12, 13.

Of these four struts 10, 11, 12, 13, two first struts, or front struts 10, 11, allow a child seat (not shown in FIG. 1) to be supported. These struts extend from the front of the chassis to the rear of the chassis.

These front struts 10, 11 each comprise one pushing arm 101, 111 and one front leg 102, 112.

The pushing arms 101, 111 are equipped with handles 103, 113 designed to be gripped by the user in order to maneuver the pushchair during normal use.

The front legs 102, 112 themselves comprise two portions 1021, 1022, 1121, 1122 able to be telescoped into one another. More precisely, the portion 1022 may be retracted inside the portion 1021, and the portion 1122 may enter the portion 1121.

The generally hammock-shaped baby seat hangs from the portions 1021, 1121.

Portions 1022, 1122 comprise at their ends a wheel support (not shown). Two shafts (not shown) are attached to the front ends 1023, 1123 of these front legs 102, 112. The front wheels are mounted on these shafts (not shown) such that they may rotate about these axes.

In a manner known per se, these shafts may be installed such that they themselves may be rotated, in particular when the user wishes to change the direction of the pushchair.

The chassis 1 further comprises second struts, in this case lower struts 12, 13 which extend from the front of the chassis to the rear of the chassis. These lower struts comprise, at each of their ends 1023, 1123, 1223, 1323, a respective wheel support. In other words, the rear wheels are mounted, via shafts (not shown), on the rear ends 1223, 1323 of the lower struts 12, 13, and the front wheels are mounted on the ends 1023, 1123 of the struts 10, 12 and 11, 13.

In the opened configuration, as shown in FIG. 1, the first struts 10, 11 are at an angle to the plane of the wheels and to the plane of the second struts 12, 13.

The struts 12, 13 are themselves designed in two portions 121, 122, 131, 132. The portions 121 and 122 may be telescoped into one another and the portions 131 and 132 may also be telescoped into one another.

The portions 101, 111, or pushing arms, may be telescoped into the portions 1021, 1121 of the front struts 10, 11.

The struts 10 and 12 are articulated to one another, at the end 1023. In other words, this end 1023 is arranged so as to allow an angular movement between these struts 10 and 12.

In the opened position, as shown in FIG. 1, the angular separation between the strut 10 and the strut 12, of the order of 45°, is greater than the angular separation in the folded position, of the order of 0°, as shown in FIG. 4. In the embodiment shown, the struts 10 and 12 are, in the folded configuration, parallel or substantially parallel to one another.

This is also the case for the struts 11 and 13 which are articulated by means of a similar mechanism.

FIG. 2 shows, in more detail, the articulation between the struts 10 and 12 and between the struts 11 and 13. An articulation part 20, 22 secures these struts 10 and 12, 11 and 13 to one another. This part comprises orifices 201, 221, into which shafts can be inserted, these shafts being secured to the corresponding struts 10, 11, so as to allow the struts 10, 11 to rotate with respect to the elements 20, 22. These rotations occur about respective axes which are slightly inclined with respect to the horizontal, such that folding in this manner reduces not only the height but also the width between the struts 10, 11, 12, 13.

Moreover, the struts 11, 13 are secured to the parts 20, 22 by respective rigid connections.

The chassis 1 further comprises two support parts 70, 72 secured to the parts 20, 22 by respective rigid connections. These support parts 70, 72 are also secured to two stem elements 30, 32 by respective articulated connections. These two elements 30, 32 are secured to one another at their other ends, by an articulated connection. These articulated connections allow rotations about substantially vertical axes.

Thus, in this embodiment, the front strut 10 is articulated not only to the lower strut 11 on the same side, but also with respect to the struts 11, 13 of the other side. Indeed, each of the struts 10, 11, 12, 13 is articulated with respect to the other struts.

With reference to FIG. 4, these elements 30, 32 define stops 80, 82 preventing any rotation movement which would bring the elements 30, 32 toward the outside of the chassis. When passing into the folded configuration, the elements 30, 32 are therefore folded on top of one another inside the chassis, as shown in FIG. 4.

The chassis of FIG. 1 may pass from an opened configuration, as shown in FIG. 1, to a folded configuration, as shown in FIG. 4. Passing from one configuration to the other in this way is effected on one hand by bringing together, in regular fashion, the struts 10 and 11 and the struts 11 and 13, in this case making these struts 10, 12 substantially parallel to one another and the struts 11, 13 substantially parallel to one another, and on the other hand by reducing the length of the struts 10, 11, 12, 13.

Reducing the angle between the struts can be used to reduce the height and the width of the chassis, while telescoping each strut reduces the length of each strut. It is thus possible to obtain a chassis which is relatively compact in the folded configuration.

It is also to be noted that, in the opened configuration, the struts 10 and 11 are not parallel to one another and that the struts 12 and 13 are not parallel to one another either. Thus, the front of the chassis 1 is not as wide as the rear of the chassis 1.

The chassis 1 comprises, in its front portion, the two stem elements 30, 32 which are articulated to one another. Thus, when passing from the opened configuration to the folded configuration, these elements 30, 32 are folded with respect to one another, by a movement toward the interior of the chassis, making it possible to further reduce the width of the chassis 1. This movement is caused by a force exerted by the user on a handle 90, called the guide handle. This force, directed toward the interior of the chassis, makes it possible to push the ends of the stem elements 30, 32 toward the interior of the chassis 1, and thus to reduce the width between the front wheels.

The chassis 1 is also arranged such that it is possible, in a single action, to fold the struts 10, 11, 12, 13 and to telescope each of these struts 10, 11, 12, 13.

The struts 10, 11, 12, 13 are brought back against one another so as to form a bundle by pulling on a generally stem-shaped tool 40. This tool 40 comprises at one end a handle 41 and its other end 42 is secured to a connecting element 50.

The tool 40 is received in a passage of the guide handle 90.

The generally stem-shaped tool 40 itself comprises several portions 401, 402 mounted such that they can slide with respect to one another, in this case two tubes 401, 402, one of which, 402, has an external diameter which is slightly smaller than the internal diameter of the other tube 401, such that it can be telescoped into this tube 401.

The connecting element is secured to each of the struts 10, 11, 12, 13 by respective stems 60, 61, 62, 63. Each of these stems 60, 61, 62, 63 is mounted articulated to a respective strut 10, 11, 12, 13 by one of its ends, and the other of its ends is articulated to the connecting element 50.

This X-shaped structure makes it possible to simultaneously fold the struts 10, 11, 12, 13, and telescope these struts.

In order to avoid the pushchair collapsing in the opened configuration, the chassis further comprises two locking fingers (not shown) which are mounted on springs on the portion 402 of the tool 40:
a first finger able to be accommodated in a cavity (not shown) inside the guide handle 90, so as to lock the end of the tool 40,
a second finger able to abut against the end of the portion 401, so as to prevent the portions 401, 402 from telescoping into one another.

The tool 40 thus comprises two respective orifices (not shown) so as to allow these fingers to pass in order to enable locking.

A mechanism (not shown) makes it possible to force the first and second fingers to be retracted inside the portion 402, in order to unlock the tool 40. This mechanism is controlled by a pushbutton (not shown) mounted on the handle 41.

Thus, when the user wishes to pass from the opened configuration of FIG. 1 to the folded configuration of FIG. 4, the user first presses on this pushbutton (not shown), to unlock the tool 40.

The user then pulls on the handle 41, and presses on the guide handle 90.

The elements 30, 32 are thus brought back against one another. The stems 60, 61, 62, 63 are also brought back against their respective struts 10, 11, 12, 13 and these struts 10, 11, 12, 13 are folded back against one another so as to obtain a generally bundle-shaped intermediate state.

Then, when the user continues to pull on the stem 40, this pulling causes the portions 1021 and 1022 to telescope into one another and, simultaneously, the portions 1121, 1122, the portions 121, 122 and the portions 131, 132 will telescope into one another.

The user may then push on the handles 103, 113 so as to telescope the pushing arms 101, 11 into the portions 1021, 1121.

Finally, the user pushes on the tool 40, so as to retract the portions 401, 402 into one another.

The chassis in the folded state is thus relatively compact. In the embodiment, the length of the chassis in the folded configuration may be close to 40% of the length of the front struts in the opened configuration.

FIG. 3 shows the connecting element 50 in more detail. This element defines a ball-ended connection with the generally stem-shaped tool 40, so as to allow angular variations between the tool 40 and the connecting element 50. Indeed, while folding the pushchair, the angle between these parts 40, 50 may vary by approximately twenty degrees.

The part 50 is further arranged so as to allow the stems 60, 61, 62, 63 to pivot about respective articulation axes.

By contrast, the part 50 defines a base that prevents the stems from exceeding certain pivot angles. It is thus possible to prevent the stems from tipping toward the outside of the chassis, which would cause the pushchair in the opened configuration to collapse.

In the embodiment of FIG. 5, the chassis 1′ comprises two front struts 10′, 11′ and two lower struts 12′, 13′. These struts 10′, 11′, 12′ and 13′ comprise several portions which are able to telescope into one another. Moreover, the struts 10′ and 12′ may be brought against one another, by rotation about an axis (D).

A set of stems 40′, 210′, 211′, 212′, 213′, 250′ and 251′ makes it possible both to fold the struts 10′, 11′, 12′ and 13′ against one another and to telescope each of these struts 10′, 11′, 12′ and 13′.

A respective stem 210′, 211′, 212′, 213′ is mounted in articulated fashion on each strut 10′, 11′, 12′, 13′. The stems 210′ and 212′ are articulated to one another and may be folded toward one another by rotation about a horizontal axis (D′). In addition, the stems 211′ and 213′ are articulated to one another and may be folded toward one another by rotation about the horizontal axis (D′).

Endstops make it possible to limit the travel of the rotations and thus to prevent the displacements which would bring the stems 210′, 211′, 212′, 213′ toward the outside of the chassis 1′.

The stems 251′, 250′ are mounted articulated to the stems 210′, 212′ and 211′, 213′, so as to allow rotations in the plane of the stems 40′, 250′ and 251′. Endstops make it possible to limit the travel of the rotations so as to prevent the displacements which would bring the stems 250′, 251′ toward the outside of the chassis 1′.

The stem 40′ comprises at one end a handle and its other end is mounted articulated to the stems 250′, 251′.

When the user pulls on this handle, the stems 250′, 251′ are rotated toward the inside of the chassis 1′ and the stems 210′, 211′, 212′, 213′ also pivot toward the inside of the chassis 1′.

FIG. 5 also shows a child support, in this case a hammock-type seat 500.

1. A folding chassis for an umbrella-fold child's pushchair, comprising:
at least one first strut, for supporting at least one front wheel at the front of the chassis and a child support, and
at least one second strut for supporting at least one rear wheel at the rear of the chassis,
in which at least one first strut and at least one second strut are articulated to one another such that, when the chassis is in an opened configuration, the first strut is at an angle to the plane of the wheels and extends from the front to the rear of the chassis and, when the chassis is in a folded configuration, the angular separation between these two struts is smaller than when the chassis is in an opened configuration,
characterized in that
each of said two struts articulated to one another comprises several portions designed to slide with respect to one another in a longitudinal direction of said strut.

2. The folding chassis as claimed in claim 1, in which at least one second strut comprises a lower strut for supporting at least one front wheel and at least one rear wheel of the chassis.

3. The folding chassis as claimed in claim 1, comprising two first struts and/or two second struts.

4. The folding chassis as claimed in claim 3, arranged such that, when said chassis is in the opened configuration, the two first struts and/or the two second struts form a non-zero angle between them, and arranged such that,
when passing from the opened configuration to the folded configuration, the angle between the two first struts and/or the angle between the two second struts decrease(s).

5. The folding chassis as claimed in claim 1, arranged so as to cause at least certain portions of said at least two struts to slide simultaneously.

6. The folding chassis as claimed in claim 1, further comprising
means for causing the at least two struts to move together in the angular direction.

7. The folding chassis as claimed in claim 6, in which the means for causing the at least two struts to move together in the angular direction also make it possible to cause at least certain portions of said at least two struts to slide simultaneously.

8. The folding chassis as claimed in claim 6, in which the means for causing the angular closing movement comprise a generally stem-shaped tool secured to each of the struts.

9. The folding chassis as claimed in claim 8, in which said generally stem-shaped tool itself comprises several portions mounted so as to be able to slide with respect to one another.

10. The folding chassis as claimed in claim 8, in which the chassis comprises locking means to lock the chassis in the opened configuration,
characterized in that
the locking means are arranged so as to lock the generally stem-shaped tool.

11. The folding chassis as claimed in claim 1, further comprising two stem elements articulated to each other at two respective ends, and articulated to two respective first struts at the other two respective ends.

12. A child's pushchair device comprising a chassis as claimed in claim 1, a child support and wheels.
